(19) United States
(12) Patent Application Publication
(10) Pub. No.: US 2026/0291611 A1
(43) Pub. Date: Sep. 24, 2026

(54) OPTICAL TRANSCEIVER

(71) Applicant: Industrial Technology Research Institute, Hsinchu (TW)

(72) Inventors: Yi-Chen Lin, Taipei City (TW); Ming-Hsien Wu, Hsinchu County (TW); Sin-Jhu Wun, Hsinchu County (TW); Fu-An Tu, Hsinchu County (TW)

(73) Assignee: Industrial Technology Research Institute, Hsinchu (TW)

(21) Appl. No.: 19/537,510

(22) Filed: Feb. 12, 2026

Related U.S. Application Data
(60) Provisional application No. 63/767,537, filed on Mar. 5, 2025.

(30) Foreign Application Priority Data
Jan. 30, 2026 (TW) 115103874

(51) Int. Cl. H04B 10/40; H04B 10/25; H04B 10/50; H04B 10/69

(52) U.S. Cl. CPC H04B 10/40; H04B 10/2589; H04B 10/502; H04B 10/506; H04B 10/691

(57) ABSTRACT

An optical transceiver includes a transmitter, an optical fiber bundle and a receiver. The transmitter includes a light source array. The light source array includes a plurality of light sources. Each of the light sources is configured to emit a plurality of lights with different wavelengths. The optical fiber bundle includes a plurality of channels. One end of the optical fiber bundle is coupled to the transmitter. The receiver includes a photosensor array. The photosensor array includes a plurality of photosensors. An other end of the optical fiber bundle is coupled to the receiver, so that the photosensors are configured to receive the lights emitted by the light sources. Each of the light sources is coupled to at least one channel of the optical fiber bundle, and each of the photosensors, corresponding to one of the light sources, is coupled to at least one channel of the optical fiber bundle.

### CROSS-REFERENCE TO RELATED APPLICATION

This application claims the priority benefit of U.S. provisional application ser. no. 63/767,537, filed on Mar. 5, 2025, and Taiwan application serial no. 115103874, filed on Jan. 30, 2026. The entirety of each of the above-mentioned patent applications is hereby incorporated by reference herein and made a part of this specification.

### TECHNICAL FIELD

The disclosure relates to an optical transceiver.

### BACKGROUND

In view of the increasing deployment of artificial intelligence and high-performance computing, transmission bandwidth must be effectively enhanced. However, increases in transmission bandwidth are frequently accompanied by escalating power consumption. For example, co-packaged optics (CPO), as presently adopted in silicon-photonics communications, may satisfy high-bandwidth requirements; however, heat dissipation and power consumption constitute issues that cannot be disregarded. Even where copper wires are employed to mitigate heat dissipation concerns, power consumption nevertheless increases as transmission distance grows.

In addition, the use of micro light-emitting diodes (micro LEDs) as light sources for short-distance optical data transmission, in combination with multi-channel transmission, may address the foregoing bottlenecks; notwithstanding, such an approach remains encumbered by issues such as the high manufacturing cost of multi-channel optical fibers, increased alignment complexity, and expanded spatial requirements, thereby resulting in inadequate space for component placement.

### SUMMARY

An optical transceiver that may further improve transmission bandwidth is provided in the disclosure.

An optical transceiver is provided in the disclosure. The optical transceiver includes a transmitter, an optical fiber bundle, and a receiver. The transmitter includes a light source array. The light source array includes multiple light sources. Each of the light sources is configured to emit multiple lights with different wavelengths. The optical fiber bundle includes multiple channels. One end of the optical fiber bundle is coupled to the transmitter. The receiver includes a photosensor array. The photosensor array includes multiple photosensors. An other end of the optical fiber bundle is coupled to the receiver, so that the photosensors are configured to receive the lights emitted by the light sources. Each of the light sources is coupled to at least one of the channels of the optical fiber bundle, and each of the photosensors, corresponding to one of the light sources, is coupled to the at least one channel of the optical fiber bundle.

Based on the above, in one embodiment of the disclosure, the optical transceiver includes a transmitter, an optical fiber bundle, and a receiver. Each of the light sources at the transmitter is configured to emit multiple lights with different wavelengths. The receiver includes multiple photosensors. One end of the optical fiber bundle is coupled to the transmitter, and an other end of the optical fiber bundle is coupled to the receiver, so that the photosensors are configured to receive the lights emitted by the light sources. In other words, optical transceivers may use multi-wavelength light sources for transmission, which increases the transmission density and bandwidth of the channel.

### BRIEF DESCRIPTION OF THE DRAWINGS

FIG. 1 is a schematic diagram of an optical transceiver according to a first embodiment of the disclosure.

FIG. 2 is a schematic diagram of an optical transceiver according to a second embodiment of the disclosure.

FIG. 3 is a schematic diagram of an optical transceiver according to a third embodiment of the disclosure.

FIG. 4 is a schematic diagram of an optical transceiver according to a fourth embodiment of the disclosure.

FIG. 5 is a schematic diagram of an optical transceiver according to a fifth embodiment of the disclosure.

FIG. 6 is a schematic diagram of an optical transceiver according to a sixth embodiment of the disclosure.

FIG. 7 is a schematic diagram of an optical transceiver according to a seventh embodiment of the disclosure.

FIG. 8 is a schematic diagram of an optical transceiver according to an eighth embodiment of the disclosure.

FIG. 9 is a schematic diagram of an optical transceiver according to a ninth embodiment of the disclosure.

FIG. 10 is a schematic diagram of auxiliary light sources in an optical transceiver according to an embodiment of the disclosure.

FIG. 11 is a schematic diagram of auxiliary light sources in an optical transceiver according to another embodiment of the disclosure.

FIG. 12 is a schematic diagram of auxiliary light sources in an optical transceiver according to yet another embodiment of the disclosure.

FIG. 13 is a schematic diagram of an optical transceiver module according to a first embodiment of the disclosure.

FIG. 14 is a three-dimensional cross-sectional diagram of an optical transceiver module according to an embodiment of the disclosure.

FIG. 15 is a three-dimensional cross-sectional diagram of an optical transceiver module according to another embodiment of the disclosure.

FIG. 16 is a schematic diagram of an optical transceiver module according to a second embodiment of the disclosure.

FIG. 17 is a schematic diagram of an optical transceiver module according to a third embodiment of the disclosure.

FIG. 18 is a schematic diagram of an optical transceiver module according to a fourth embodiment of the disclosure.

FIG. 19 is a schematic diagram of an optical transceiver module according to a fifth embodiment of the disclosure.

FIG. 20A is a schematic diagram of an optical transceiver system according to a first embodiment of the disclosure.

FIG. 20B is a three-dimensional schematic diagram of an example of a microlens array in an optical transceiver system according to an embodiment of the disclosure.

FIG. 21 is a three-dimensional schematic diagram of another example of a microlens array in an optical transceiver system according to an embodiment of the disclosure.

FIG. 22 is a three-dimensional schematic diagram of yet another example of a microlens array in an optical transceiver system according to an embodiment of the disclosure.

FIG. 23 is a schematic diagram of an optical transceiver system according to a second embodiment of the disclosure.

FIG. 24 is a schematic diagram of an optical transceiver system according to a third embodiment of the disclosure.

### DETAILED DESCRIPTION OF DISCLOSED EMBODIMENTS

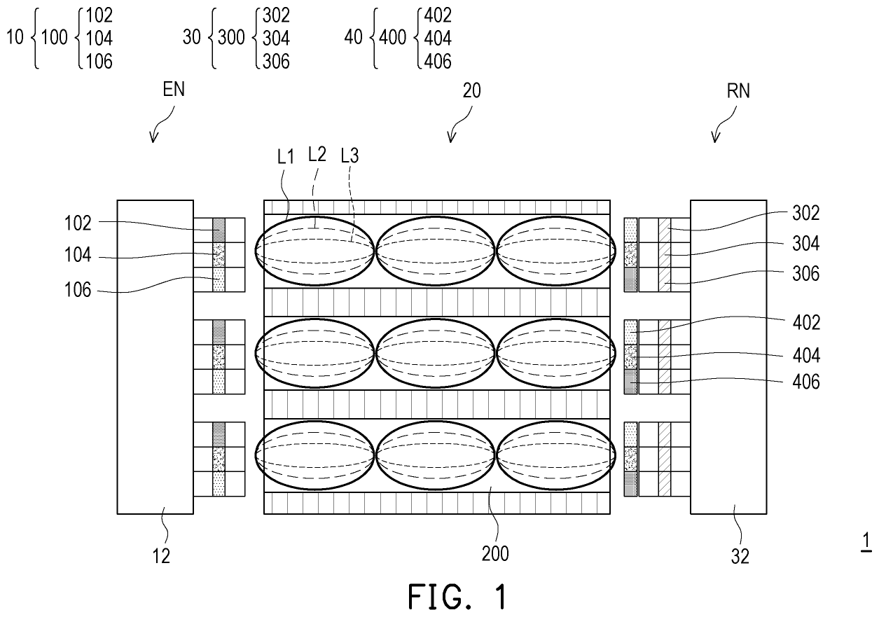

FIG. 1 is a schematic diagram of an optical transceiver according to a first embodiment of the disclosure. Referring to FIG. 1, an embodiment of the disclosure provides an optical transceiver 1, which may include a transmitter EN, an optical fiber bundle 20, and a receiver RN. The transmitter EN includes a light source array 10. The light source array 10 may include multiple light sources 100. Each of the light sources 100 is configured to emit multiple lights L1, L2, and L3 with different wavelengths. The optical fiber bundle 20 may include multiple channels 200. One end of the optical fiber bundle 20 is coupled to the transmitter EN. The receiver RN may include a photosensor array 30. The photosensor array 30 may include multiple photosensors 300. An other end of the optical fiber bundle 20 is coupled to the receiver RN, so that the photosensors 300 are configured to receive the light L1, L2, and L3 emitted by the light sources 100. Each of the light sources 100 is coupled to at least one channel 200 of the optical fiber bundle 20, and each of the photosensors 300, corresponding to one of the light sources 100, is coupled to at least one channel 200 of the optical fiber bundle 20.

In detail, in this embodiment, the light source array 10 may be a micro light-emitting diode array. Each of the light sources 100 in the light source array 10 may include multiple sub-light sources 102, 104, and 106. The sub-light sources 102, 104, and 106 are configured to emit the multiple lights L1, L2, and L3 with different wavelengths, respectively. The lights L1, L2, and L3 may be red light, green light, and blue light, respectively. However, the disclosure is not limited to the type of light source array 10 and the light colors of the lights L1, L2, and L3.

In this embodiment, the photosensor array 30 may adopt a photodiode formed of silicon, germanium, III-V semiconductors, or nitride semiconductors, and its detection light band may correspond to ultraviolet light, visible light, infrared light, near-infrared light, and mid-infrared light bands. However, the disclosure is not limited to the type of photosensor array 30. For example, the photosensor array 30 may be a silicon photodiode array. Each of the photosensors 300 in the photosensor array 30 may include multiple sub-photosensors 302, 304, and 306. The positions of the sub-photosensors 302, 304, and 306 correspond to the positions of one of the sub-light sources 102, 104, and 106 of the light sources, respectively, so as to receive the multiple lights L1, L2, and L3 with different wavelengths, respectively.

In this embodiment, the optical transceiver 1 may further include a bandpass filter array 40. The bandpass filter array 40 may include multiple bandpass filters 400. The bandpass filters 400 correspond to the positions of the light sources 100, respectively, and are disposed between the optical fiber bundle 20 and the receiver RN. Each of the bandpass filters 400 may include multiple sub-bandpass filters 402, 404, and 406. The sub-bandpass filters 402, 404, and 406 have different passbands, respectively, correspond to the positions of the sub-light sources 102, 104, and 106, respectively, and are disposed between the optical fiber bundle 20 and the receiver RN. The passbands of the sub-bandpass filters 402, 404, and 406 are preferably designed to correspond to the wavelengths of lights L1, L2, and L3. For example, the sub-bandpass filter 402 may allow red light to pass through while filtering other colors of light, the sub-bandpass filter 404 may allow green light to pass through while filtering other colors of light, and the sub-bandpass filter 406 may allow blue light to pass through while filtering other colors of light. However, the disclosure is not limited to the passbands of the sub-bandpass filters 402, 404, and 406.

In addition, the light source array 10 may also include a substrate 12, and the light sources 100 are disposed on the substrate 12. The photosensor array 30 may also include a substrate 32, and the photosensors 300 are disposed on the substrate 32. The substrates 12 and 32 may be substrates used by the light sources 100 and the photosensors 300 in single or mass transfer. The aforementioned transfer methods may be vacuum, electrostatic, viscous, or laser transfer.

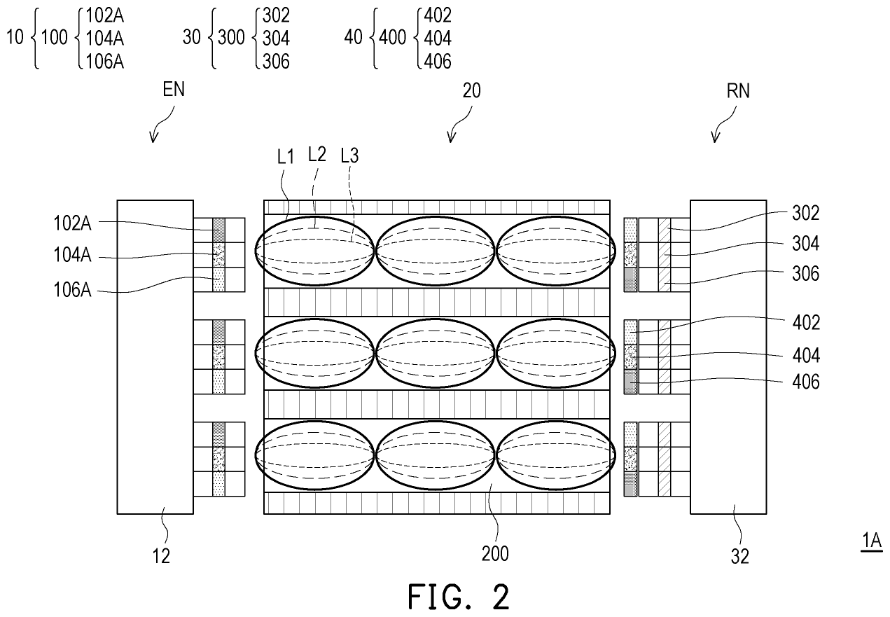

FIG. 2 is a schematic diagram of an optical transceiver according to a second embodiment of the disclosure. Referring to FIG. 2, the optical transceiver 1A is similar to the optical transceiver 1 in FIG. 1. The main difference is that the sub-light sources 102A, 104A, and 106A may be wavelength-tunable light sources.

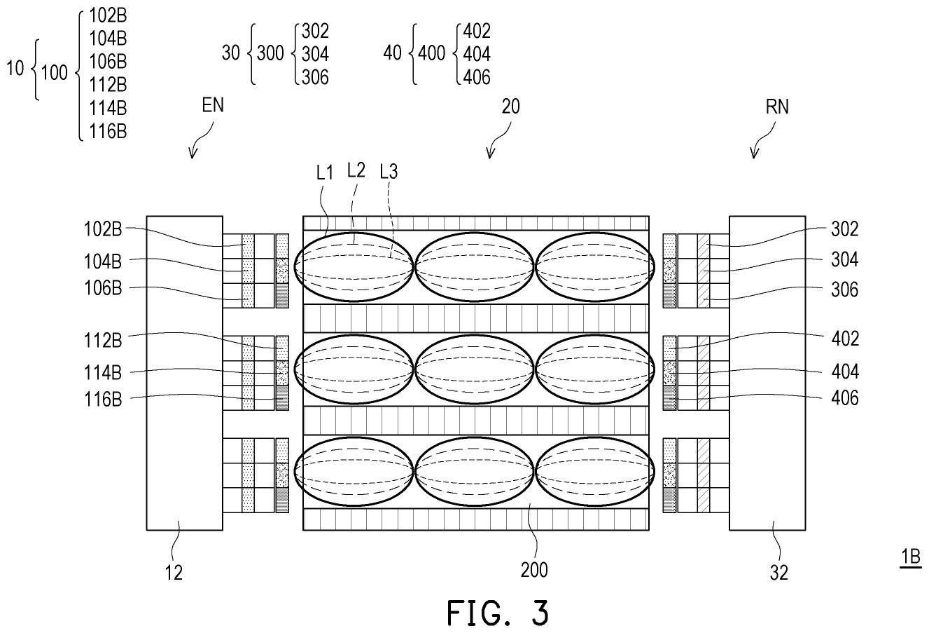

FIG. 3 is a schematic diagram of an optical transceiver according to a third embodiment of the disclosure. Referring to FIG. 3, the optical transceiver 1B is similar to the optical transceiver 1 in FIG. 1. The main difference is that each of the light sources 100 of the light source array 10 further includes multiple wavelength conversion elements 112B, 114B, and 116B. The wavelength conversion elements 112B, 114B, and 116B correspond to the positions of the sub-light sources 102B, 104B, and 106B, respectively, and are disposed between the sub-light sources 102B, 104B, and 106B and the optical fiber bundle 20, so as to convert the light emitted by the sub-light sources 102B, 104B, and 106B into multiple lights L1, L2, and L3 with different wavelengths, respectively. The lights emitted by the sub-light sources 102B, 104B, and 106B may have the same or different light colors. For example, the sub-light sources 102B, 104B, and 106B may emit blue light, and the wavelength conversion elements 112B, 114B, and 116B are configured to convert blue light into red light, green light, and blue light. However, the disclosure is not limited to the colors of light emitted by the sub-light sources 102B, 104B, and 106B, nor is it limited to the colors of light absorbed by the wavelength conversion elements 112B, 114B, and 116B, respectively, and the colors of light they convert into.

In this embodiment, the optical transceiver 1B may further include a bandpass filter array 40. The bandpass filter array 40 may include multiple bandpass filters 400. The bandpass filters 400 correspond to the positions of the light sources 100 and are positioned between the optical fiber bundle 20 and the receiver RN. Each of the bandpass filters 400 may include multiple sub-bandpass filters 402, 404, and 406. The sub-bandpass filters 402, 404, and 406 have different passbands, respectively, correspond to the positions of the sub-light sources 102, 104, and 106, respectively, and are disposed between the optical fiber bundle 20 and the receiver RN.

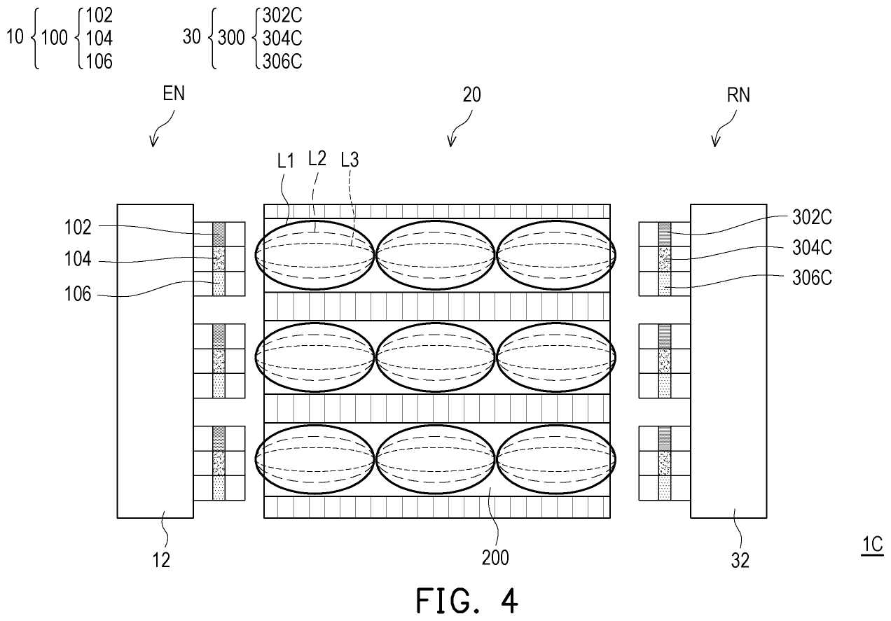

FIG. 4 is a schematic diagram of an optical transceiver according to a fourth embodiment of the disclosure. Referring to FIG. 4, the optical transceiver 1C is similar to the optical transceiver 1 in FIG. 1. The main difference is that the sub-photosensors 302C, 304C, and 306C may be micro light-emitting diodes with reverse bias applied.

In other words, in the optical transceiver 1 in FIG. 1 to the optical transceiver 1C in FIG. 4, the optical transceivers 1, 1A, 1B and 1C may be designed to transmit using multi-wavelength light sources, thereby increasing the transmission density and bandwidth of each channel 200.

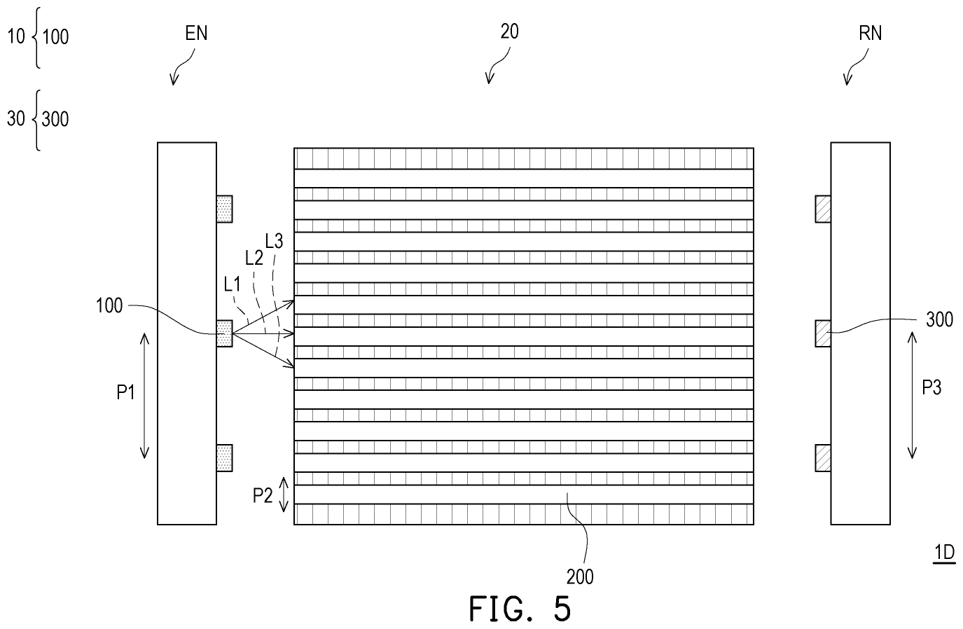

FIG. 5 is a schematic diagram of an optical transceiver according to a fifth embodiment of the disclosure. Referring to FIG. 5, the optical transceiver 1D is similar to the optical transceiver 1 in FIG. 1. The main difference is that each of the light sources 100 may be a single light source that emits the multiple lights L1, L2, and L3 with different wavelengths, and each of the photosensors 300 may also be a single sensor. Each of the light sources 100 is coupled to at least two channels 200 of the optical fiber bundle 20, and each of the photosensors 300, corresponding to one of the light sources 100, is coupled to at least two channels 200 of the optical fiber bundle 20.

Furthermore, in this embodiment, the light sources 100 are spaced by a first pitch P1, the channels 200 are spaced by a second pitch P2, and the photosensors 300 are spaced by a third pitch P3. The first pitch P1 is greater than or equal to twice the second pitch P2, and the third pitch P3 is greater than twice the second pitch P2.

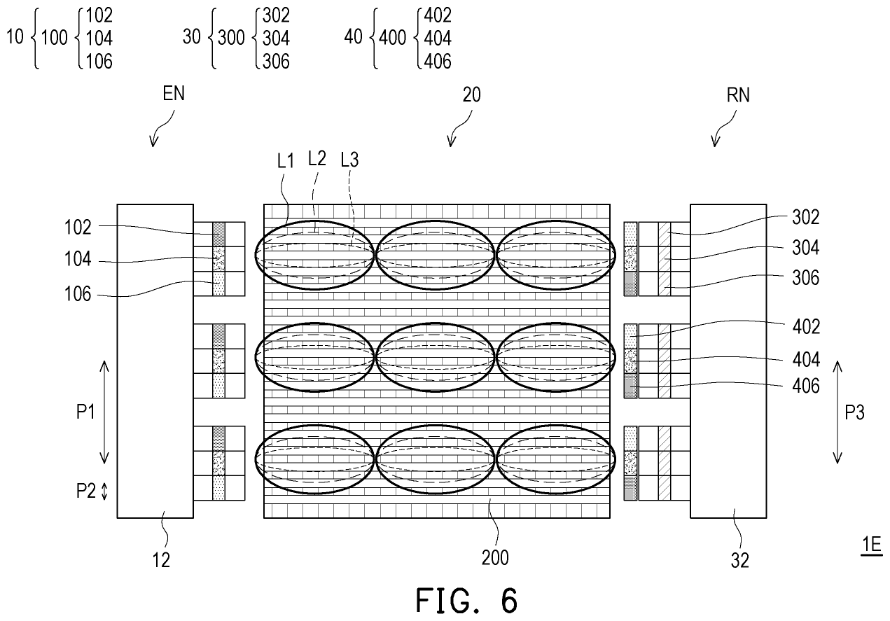

FIG. 6 is a schematic diagram of an optical transceiver according to a sixth embodiment of the disclosure. Referring to FIG. 6, the optical transceiver 1E is similar to the optical transceiver 1 in FIG. 1. The main difference is that each of the light sources 100 is coupled to at least two channels 200 of the optical fiber bundle 20, and each of the photosensors 300, corresponding to one of the light sources 100, is coupled to at least two channels 200 of the optical fiber bundle 20. The light sources 100 are spaced by a first pitch P1. The channels 200 are spaced by a second pitch P2 and the photosensors 300 are spaced by a third pitch P3. The first pitch P1 is greater than or equal to twice the second pitch P2, and the third pitch P3 is greater than twice the second pitch P2.

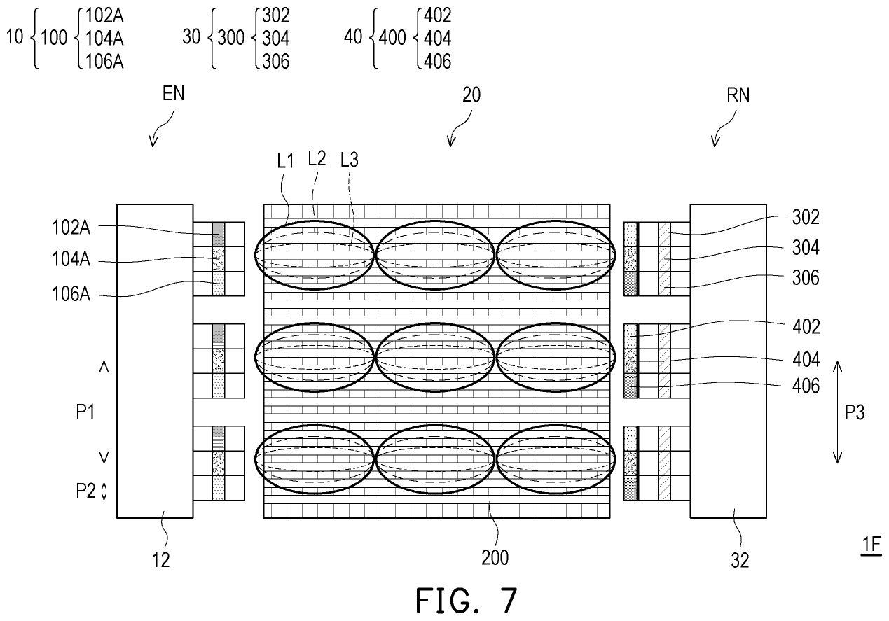

FIG. 7 is a schematic diagram of an optical transceiver according to a seventh embodiment of the disclosure. Referring to FIG. 7, the optical transceiver 1F is similar to the optical transceiver 1A in FIG. 2. The main difference is that each of the light sources 100 is coupled to at least two channels 200 of the optical fiber bundle 20, and each of the photosensors 300, corresponding to one of the light sources 100, is coupled to at least two channels 200 of the optical fiber bundle 20. The light sources 100 are spaced by a first pitch P1. The channels 200 are spaced by a second pitch P2 and the photosensors 300 are spaced by a third pitch P3. The first pitch P1 is greater than or equal to twice the second pitch P2, and the third pitch P3 is greater than twice the second pitch P2.

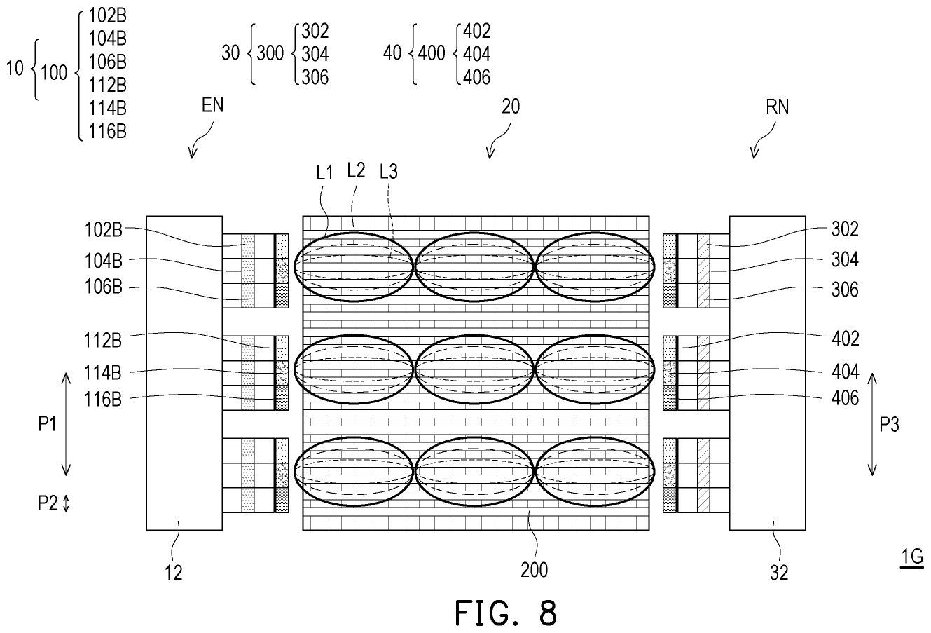

FIG. 8 is a schematic diagram of an optical transceiver according to an eighth embodiment of the disclosure. Referring to FIG. 8, the optical transceiver 1G is similar to the optical transceiver 1B in FIG. 3. The main difference is that each of the light sources 100 is coupled to at least two channels 200 of the optical fiber bundle 20, and each of the photosensors 300, corresponding to one of the light sources 100, is coupled to at least two channels 200 of the optical fiber bundle 20. The light sources 100 are spaced by a first pitch P1. The channels 200 are spaced by a second pitch P2 and the photosensors 300 are spaced by a third pitch P3. The first pitch P1 is greater than or equal to twice the second pitch P2, and the third pitch P3 is greater than twice the second pitch P2.

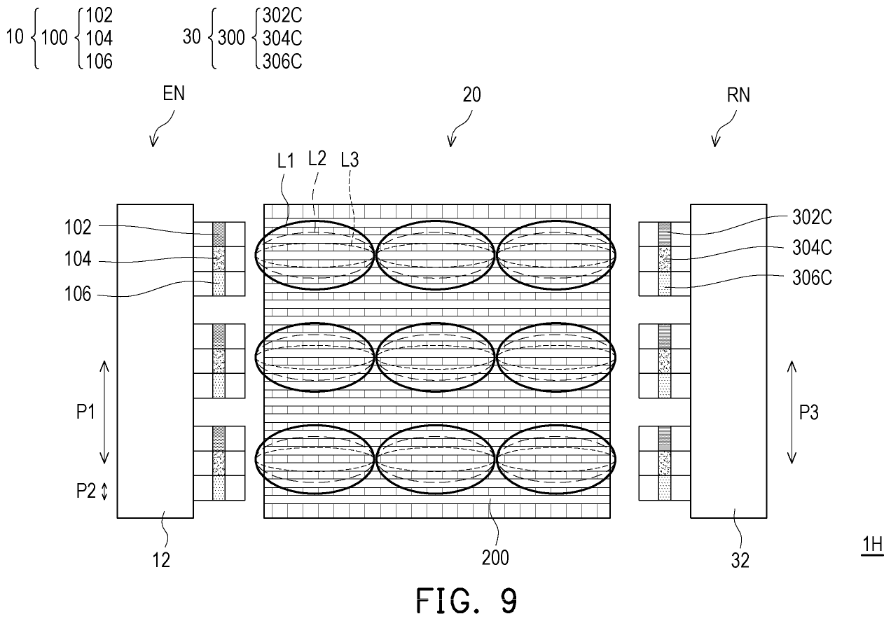

FIG. 9 is a schematic diagram of an optical transceiver according to a ninth embodiment of the disclosure. Referring to FIG. 9, the optical transceiver 1H is similar to the optical transceiver 1C in FIG. 4. The main difference is that each of the light sources 100 is coupled to at least two channels 200 of the optical fiber bundle 20, and each of the photosensors 300, corresponding to one of the light sources 100, is coupled to at least two channels 200 of the optical fiber bundle 20. The light sources 100 are spaced by a first pitch P1. The channels 200 are spaced by a second pitch P2 and the photosensors 300 are spaced by a third pitch P3. The first pitch P1 is greater than or equal to twice the second pitch P2, and the third pitch P3 is greater than twice the second pitch P2.

In other words, among the optical transceiver 1D in FIG. 5 to the optical transceiver 1H in FIG. 9, in addition to increasing the transmission density and bandwidth by using multi-wavelength light sources, the optical transceivers 1D, 1E, 1F, 1G, and 1H may further improve the transmission density and bandwidth by using multi-channel coupling design. Moreover, the coupling and alignment method between a light source 100 or a photosensor 300 with the multi-channel 200 may reduce the difficulty of optical fiber alignment and packaging, thereby reducing transmission loss caused by optical fiber arrangement tolerance.

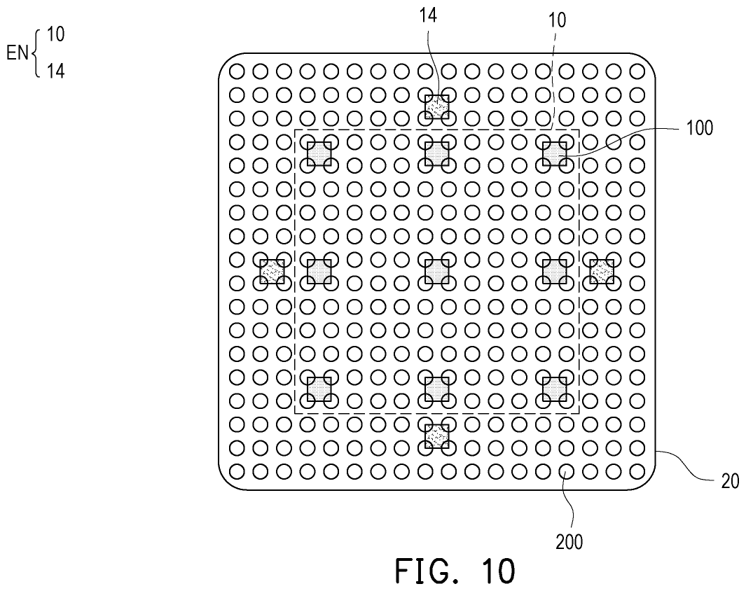

FIG. 10 is a schematic diagram of auxiliary light sources in an optical transceiver according to an embodiment of the disclosure. Referring to FIG. 10, in this embodiment, the transmitter EN may further include multiple auxiliary light sources 14. The auxiliary light source 14 is disposed around the light source array 10. Each of the auxiliary light sources 14 is configured to couple to at least one of the channels 200 to assist in the alignment between the light source array 10 and the optical fiber bundle 20.

Furthermore, in this embodiment, both the light source array 10 and the channels 200 may be arranged into a square matrix, and the length and width of the square matrix formed by the light source array 10 are parallel or perpendicular to the length and width of the square matrix formed by the channels 200.

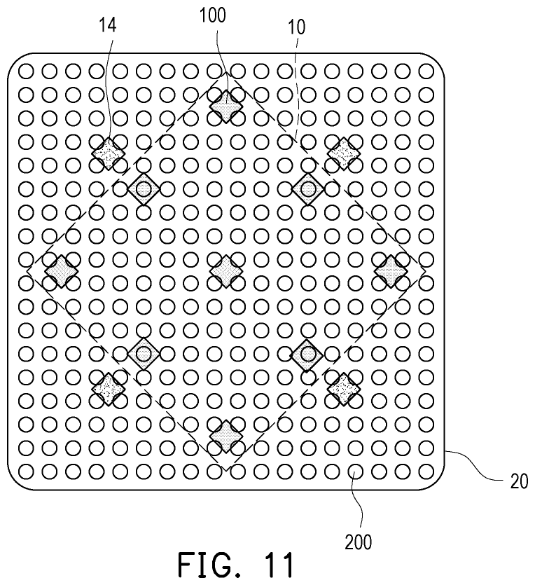

FIG. 11 is a schematic diagram of auxiliary light sources in an optical transceiver according to another embodiment of the disclosure. Referring to FIG. 11, the optical transceiver in FIG. 11 is similar to the optical transceiver in FIG. 10. The main difference is that the light source array 10 and the channels 200 are both arranged into a square matrix, and the length and width of the square matrix formed by the light source array 10 are not parallel and not perpendicular to the length and width of the square matrix formed by the channels 200.

In other words, in addition to the optical transceiver in FIG. 10 being able to use the auxiliary light sources 14 to identify the alignment and array direction between the light sources 100, the channels 200 and the photosensors 300, the optical transceiver in FIG. 11 may also rotate the light sources 100 and the photosensors 300 arbitrarily.

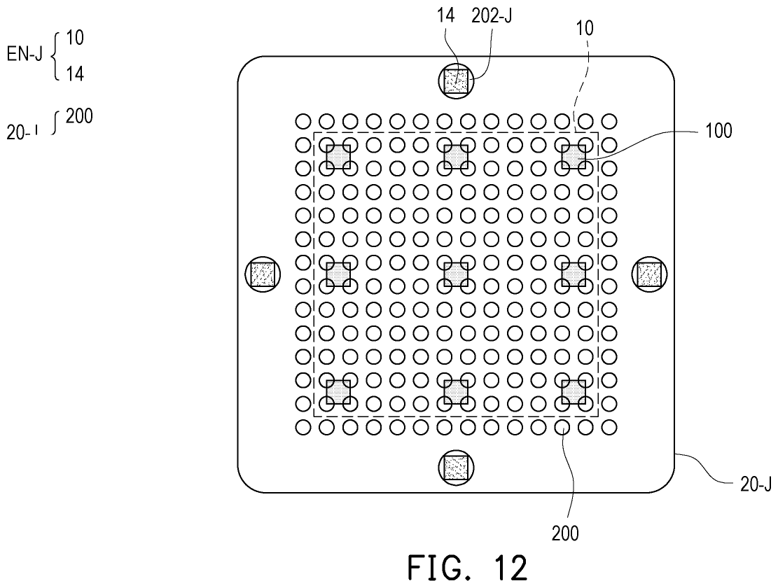

FIG. 12 is a schematic diagram of auxiliary light sources in an optical transceiver according to yet another embodiment of the disclosure. Referring to FIG. 12, the optical transceiver in FIG. 12 is similar to the optical transceiver in FIG. 10. The main difference is that the transmitter EN-J may further include multiple auxiliary light sources 14, and the optical fiber bundle 20-J may further include multiple auxiliary channels 202-J. The auxiliary light sources 14 are disposed around the light source array 10, and the auxiliary channels 202-J are disposed around the channels 200. Each of the auxiliary light sources 14 is configured to couple to one of the auxiliary channels 202-J to assist in the alignment between the light sources 100 of the light source array 10 and the channels 200 of the optical fiber bundle 202-J. The size of the optical fiber core of the auxiliary channel 202-J may be the same as or different from the size of the optical fiber core of the channel 200. For example, FIG. 12 illustrates that the size of the optical fiber core of the auxiliary channel 202-J is larger than the size of the optical fiber core of the channel 200.

Based on the above, in one embodiment of the disclosure, the optical transceiver 1 includes a transmitter EN, an optical fiber bundle 20, and a receiver RN. The transmitter EN includes a light source array 10, which includes multiple light sources 10. Each of the light sources 100 is configured to emit multiple lights L1, L2, and L3 with different wavelengths. The receiver RN includes a photosensor array 30, which includes multiple photosensors 300. One end of the optical fiber bundle 20 is coupled to the transmitter EN, and an other end of the optical fiber bundle 20 is coupled to the receiver RN, so that the photosensors 300 are configured to receive the lights L1, L2, and L3 emitted by the light sources 100. In other words, the optical transceiver 1 uses multi-wavelength light sources for transmission, thus increasing the transmission density and bandwidth of the channel.

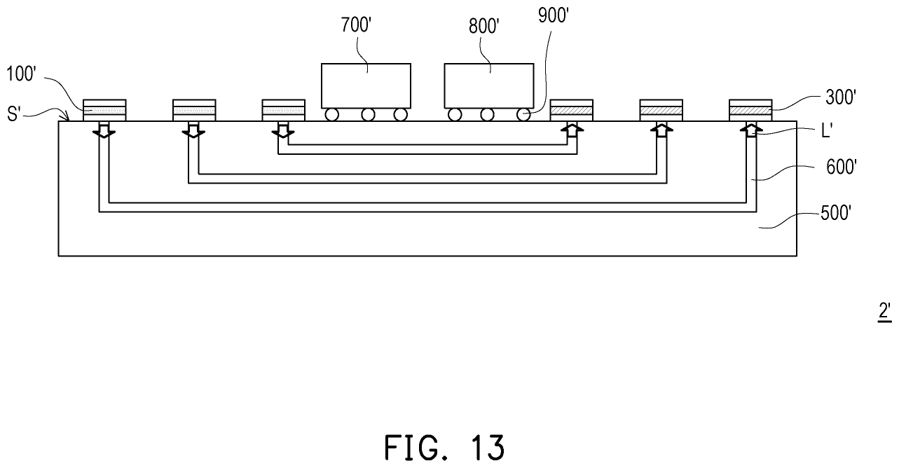

FIG. 13 is a schematic diagram of an optical transceiver module according to a first embodiment of the disclosure. Referring to FIG. 13, an embodiment of the disclosure provides an optical transceiver module 2′, which may include a substrate 500′, multiple optical waveguides 600′, multiple light sources 100′, and multiple photosensors 300′. The optical waveguides 600′ are disposed within the substrate 500′. The light sources 100′ are disposed on one surface S′ of the substrate 500′. The material of the optical waveguides 600′ may be SiN, InP, LiNbO₃, Si₃N₄, SiO Al₂O₃, Ta₂O₅, TiO₂, III-V group materials, polymers, etc., but the disclosure is not limited thereto.

In this embodiment, the light sources 100′ are configured to emit a light L′, respecitively. The light sources 100′ may be light-emitting diodes or micro light-emitting diodes. The light L′ may be red light, green light, blue light, white light, or other suitable colors. The photosensors 300′ are configured to receive the light L′. The photosensors 300′ may adopt photodiodes formed of silicon, germanium, III-V semiconductors, or nitride semiconductors, and their detection light wavelength may correspond to ultraviolet light, visible light, infrared light, near-infrared light, and mid-infrared light bands. For example, the photosensors 300′ may be photodiodes or silicon photodiodes. However, the disclosure is not limited to the type of light sources 100′ and photosensors 300′.

In this embodiment, the optical transceiver module 2′ further includes a light source driver 700′, a signal amplifier 800′, and multiple interconnections 900′. The light source driver 700′ is disposed on the surface S′ and is configured to drive the light sources 100′. The signal amplifier 800′ is disposed on the surface S′. The signal amplifier 800′ may be a transimpedance amplifier (TIA), but the disclosure is not limited thereto. The interconnections 900′ are configured to electrically connect the light sources 100′ to the light source driver 700′, or to electrically connect the photosensors 300′ to the signal amplifier 800′.

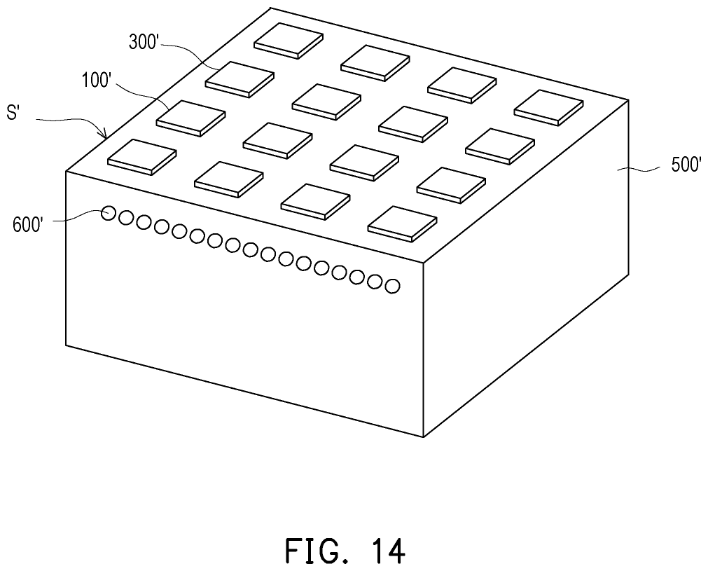

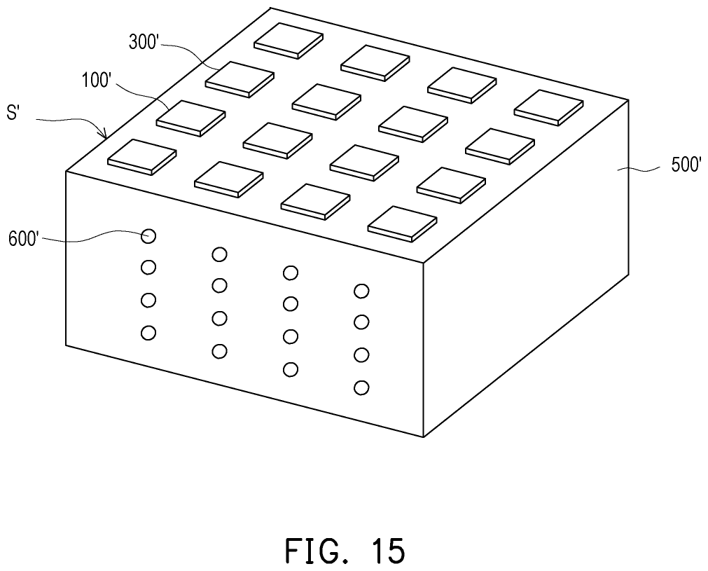

FIG. 14 is a three-dimensional cross-sectional diagram of an optical transceiver module 1′ according to an embodiment of the disclosure. FIG. 15 is a three-dimensional cross-sectional diagram of an optical transceiver module according to another embodiment of the disclosure. Referring to FIG. 14 and FIG. 15, in this embodiment, the optical waveguides 600′ may be arranged in a one-dimensional array on a cross section of the substrate 500′ perpendicular to the surface S′, as shown in FIG. 14. Alternatively, the optical waveguides 600′ may be arranged in a two-dimensional array on a cross section of the substrate 500′ perpendicular to the surface S′, as shown in FIG. 15.

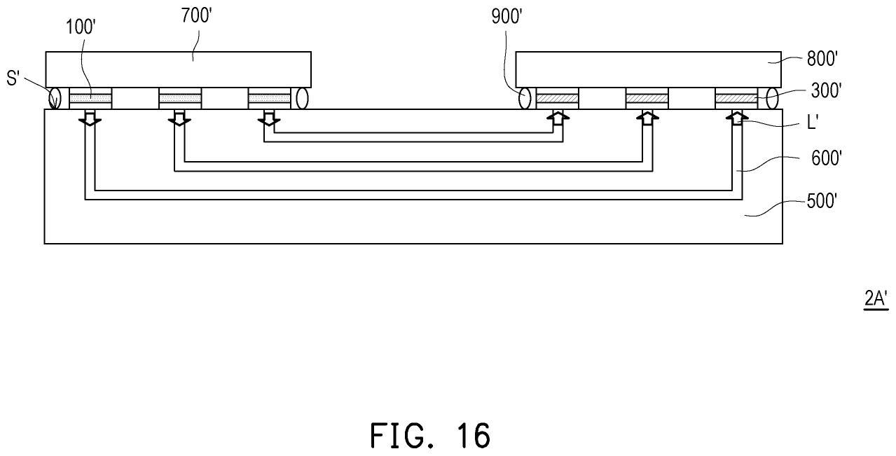

FIG. 16 is a schematic diagram of an optical transceiver module according to a second embodiment of the disclosure. Referring to FIG. 16, the optical transceiver module 2A′ is similar to the optical transceiver module 2′ in FIG. 13. The main difference is that the light sources 100′ are disposed between the light source driver 700′ and the substrate 500′, and the photosensors 300′ are disposed between the signal amplifier 800′ and the substrate 500′.

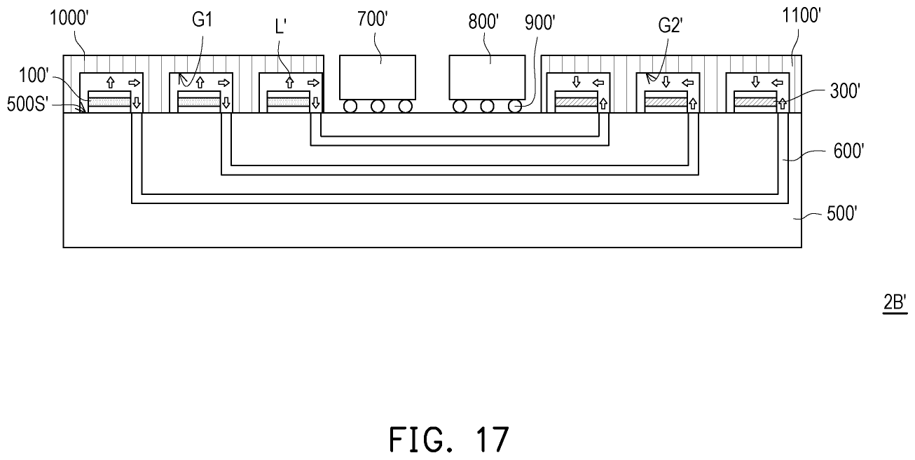

FIG. 17 is a schematic diagram of an optical transceiver module according to a third embodiment of the disclosure. Referring to FIG. 17, the optical transceiver module 2B′ is similar to the optical transceiver module 2′ in FIG. 13. The main difference is that the optical transceiver module 2B′ may further include a first light reflection structure 1000′ and a second light reflection structure 1100′. The light sources 100′ are disposed between the first light reflection structure 1000′ and the substrate 500′. The first light reflection structure 1000′ may have multiple first grooves G1′, and the first grooves G1′ are configured to accommodate the light sources 100′, respectively, and are configured to reflect the light L′ emitted by the light sources 100′ to the optical waveguides 600′, respectively. The photosensors 300′ are disposed between the second light reflection structure 1100′ and the substrate 500′. The second light reflection structure 1100′ may have multiple second grooves G2′, and the second grooves G2′ are configured to accommodate the photosensors 300′, respectively, and are configured to reflect the light L′ emitted from the optical waveguides 600′ to the photosensors 300′, respectively. The first light reflection structure 1000′ and the second light reflection structure 1100′ may be metal structures or have a reflective layer on the surface of the first groove G1′ and the second groove G2′, but the disclosure is not limited thereto.

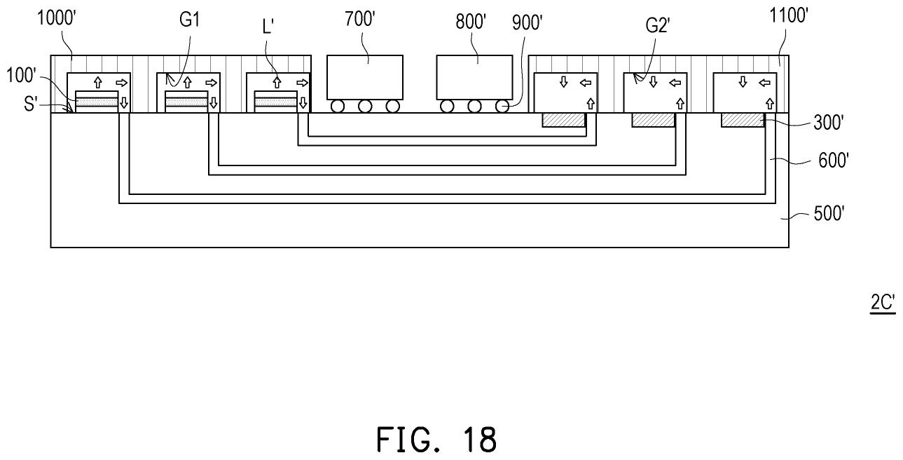

FIG. 18 is a schematic diagram of an optical transceiver module according to a fourth embodiment of the disclosure. Referring to FIG. 18, the optical transceiver module 2C′ is similar to the optical transceiver module 2B′ in FIG. 17. The main difference is that the photosensors 300′ may be embedded in the surface S′ of the substrate 500′. Therefore, the optical transceiver module 2C′ may reduce the packaging steps of the photosensors 300′ during the manufacturing process.

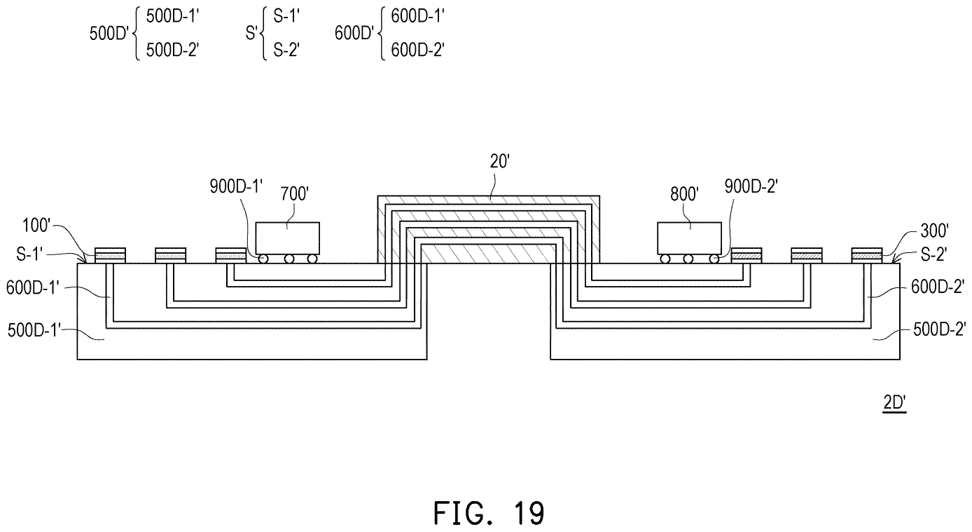

FIG. 19 is a schematic diagram of an optical transceiver module according to a fifth embodiment of the disclosure. Referring to FIG. 19, the optical transceiver module 2D′ is similar to the optical transceiver module 2′ in FIG. 13. The main difference is that the substrate 500D′ may include a first substrate 500D-1′ and a second substrate 500D-2′, and the surface S′ of the substrate 500D′ may include a first surface S-1′ and a second surface S-2′. The optical waveguides 600D′ may include multiple first optical waveguides 600D-1′ and multiple second optical waveguides 600D-2′.

In this embodiment, the optical transceiver module 1D′ may further include an optical fiber bundle 20′ (or may be a fiber array unit (FAU)). One end of the optical fiber bundle 20′ is disposed on the first surface S-1′, and an other end is disposed on the second surface S-2′. The first optical waveguides 600D-1′ are disposed within the first substrate 500D-1′. The light sources 100′ are disposed on the first surface S-1′. One end of each of the first optical waveguides 600D-1′ is configured to couple to one of the light sources 100′, and an other end is configured to couple to the one end of the optical fiber bundle 20′. The second optical waveguides 600D-2′ are disposed within the second substrate 500D-2′. The photosensors 300′ are disposed on the second surface S-2′. One end of each of the second optical waveguides 600D-2′ is configured to couple to one of the photosensors 300′, and an other end is configured to couple to the other end of the optical fiber bundle 20′.

In this embodiment, the optical transceiver module 2D′ further includes a light source driver 700′, a signal amplifier 800′, multiple first interconnections 900D-1′, and multiple second interconnections 900D-2′. The light source driver 700′ is disposed on the first surface S-1′. The signal amplifier 800′ is disposed on the second surface S-2′. The first interconnections 900D-1′ are configured to electrically connect the light sources 100′ to the light source driver 700′. The second interconnections 900D-2′ are configured to electrically connect the photosensors 300′ to the signal amplifier 800′.

In other words, traditional optical transceiver modules use optical fiber bundles for transmission, but the optical fiber bundles still require customization, resulting in higher costs. Furthermore, the optical fiber bundles are difficult to align, leading to poor coupling efficiency. Therefore, in the optical transceiver module 2′ in FIG. 13 to the optical transceiver module 2D′ in FIG. 19, the optical transceiver modules 2′, 2A′, 2B′, 2C′, and 2D′ utilize the compatibility of waveguides and the substrate manufacturing processes to enable direct optical interconnection between the optical waveguides 600′ or 600D′ and the light sources 100′ and the photosensors 300′. Therefore, the optical transceiver modules 2′, 2A′, 2B′, 2C′, and 2D′ may have smaller alignment errors, thereby improving optical coupling efficiency.

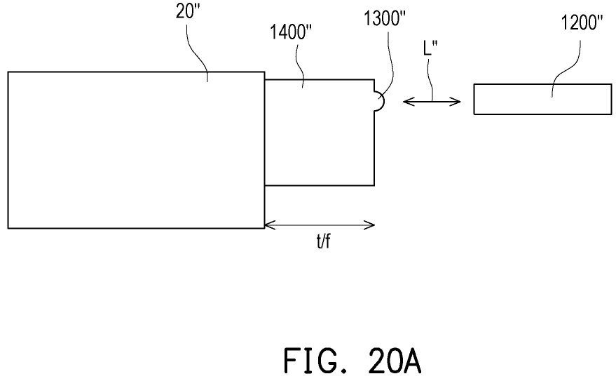

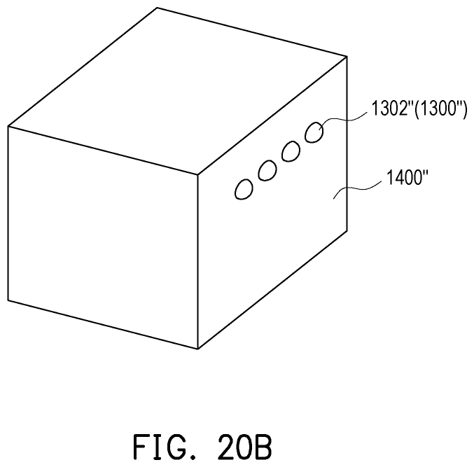

FIG. 20A is a schematic diagram of an optical transceiver system according to a first embodiment of the disclosure. FIG. 20B is a three-dimensional schematic diagram of an example of a microlens array in an optical transceiver system according to an embodiment of the disclosure. Referring to FIG. 20A and FIG. 20B, an embodiment of the disclosure provides an optical transceiver system 3″, which may include a fiber array 20″, a photonic integrated circuit (PIC) 1200″, and a microlens array 1300″. The microlens array 1300″ is coupled between the fiber array 20″ and the photonic integrated circuit 1200″, and is configured to transmit the light L″ from the fiber array 20″ to the photonic integrated circuit 1200″ or to transmit the light L″ from the photonic integrated circuit element 1200″ to the fiber array 20″.

In this embodiment, the optical transceiver system 3″ may further include a light-transmitting substrate 1400″. A light-transmitting substrate 1400″ is disposed between the fiber array 20″ and the photonic integrated circuit 1200″, in which the microlens array 1300″ is disposed on the light-transmitting substrate 1400″. The microlens array 1300″ may include multiple microlenses 1302″, and the structure of these microlenses 1302″ may be semi-circular, approximately semi-circular, arc-shaped, egg-shaped, arch-shaped, dome-shaped, or other configurations having an arc or curved outer contour, as shown in FIG. 20A, but the disclosure is not limited thereto.

In this embodiment, the focal length f of (the microlenses 1302″ of) the microlens array 1300″ may determine the thickness t of the light-transmitting substrate 1400″ from the side close to the fiber array 20″ to the side close to the photonic integrated circuit 1200″. In one embodiment, the aforementioned focal length f may be approximately equal to or equal to the thickness t, but the disclosure is not limited thereto.

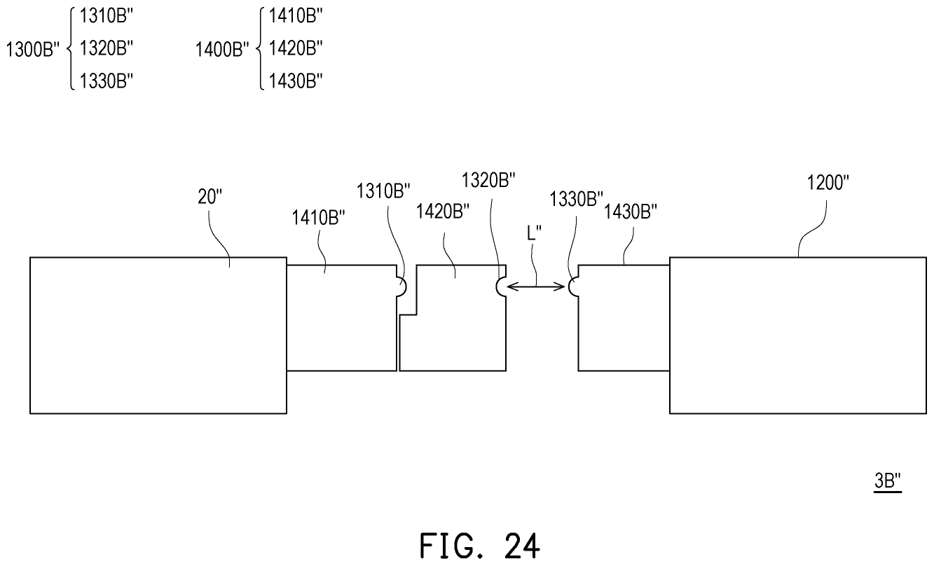

Furthermore, in this embodiment, the microlens array 1300″ may be disposed on the side of the light-transmitting substrate 1400″ away from the fiber array 20″, and the light-transmitting substrate 1400″ may be bonded to the fiber array 20″ on the side close to the fiber array 20″, as shown in FIG. 20A. Alternatively, the microlens array 1300″ may be disposed on the side of the light-transmitting substrate 1400″ close to the fiber array 20″, and the light-transmitting substrate 1400″ may be bonded to the photonic integrated circuit 1200″ on the side close to the photonic integrated circuit 1200″ (as shown in FIG. 24).

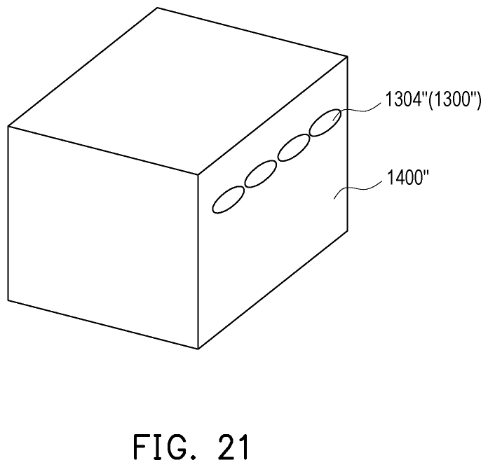

FIG. 21 is a three-dimensional schematic diagram of another example of a microlens array in an optical transceiver system according to an embodiment of the disclosure. Referring to FIG. 21, the microlens 1304″ in FIG. 21 is similar to the microlenses 1302″ in FIG. 20B. The main difference is that the structure of the microlens 1304″ may be a semi-elliptical lens or an approximately semi-elliptical lens.

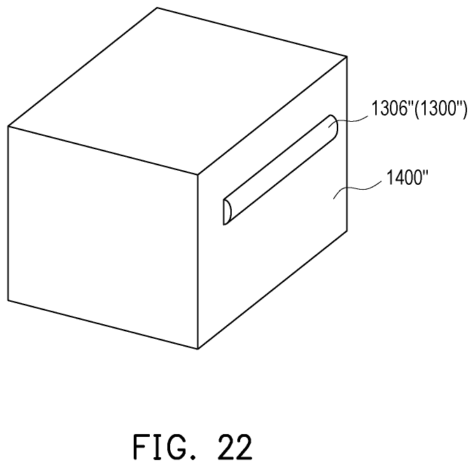

FIG. 22 is a three-dimensional schematic diagram of yet another example of a microlens array in an optical transceiver system according to an embodiment of the disclosure. Referring to FIG. 22, the microlens 1306″ in FIG. 22 is similar to the microlenses 1302″ in FIG. 20B. The main difference is that the microlens 1306″ may be a semi-cylindrical lens. Moreover, in one embodiment, the structure of each of the microlenses 1306″ may be connected with that of its adjacent microlens 1306″ to form a semi-cylindrical shape.

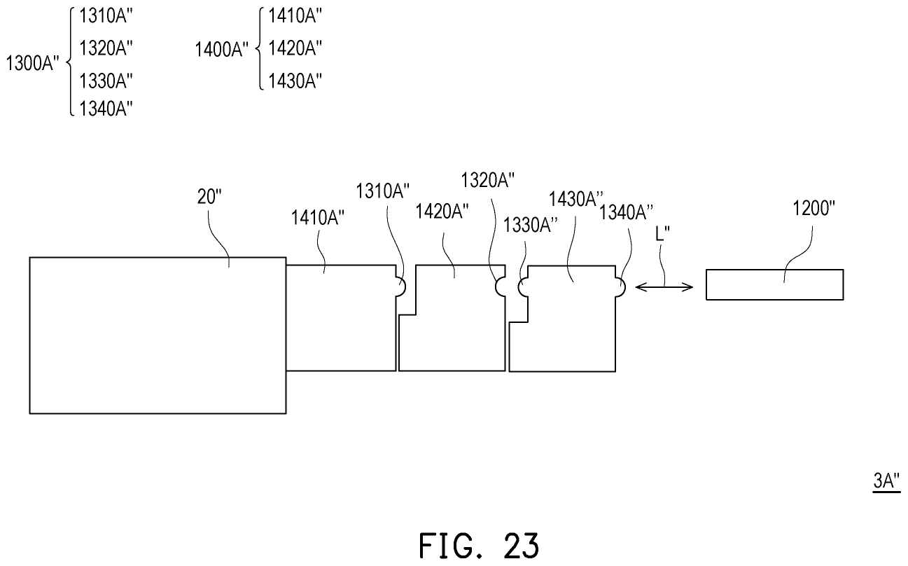

FIG. 23 is a schematic diagram of an optical transceiver system according to a second embodiment of the disclosure. Please refer to FIG. 23. The optical transceiver system 3A″ is similar to the optical transceiver system 3″ in FIG. 20A. The main difference is that the microlens array 1300A″ may include multiple sub-microlens arrays 1310A″, 1320A″, 1330A″, and 1340A″, and the light-transmitting substrate 1400A″ may include multiple sub-light-transmitting substrates 1410A″, 1420A″, and 1430A″. The sub-light-transmitting substrates 1410A″, 1420A″, and 1430A″ are stacked sequentially along the light path of the light L″. These sub-microlens arrays 1310A″, 1320A″, 1330A″, and 1340A″ may be disposed on the side of the sub-light-transmitting substrates 1410A″, 1420A″, and 1430A″ close to the fiber array 20″ or the side close to the photonic integrated circuit 1200″, respectively.

In this embodiment, the sub-microlens arrays 1310A″, 1320A″, 1330A″, and 1340A″ may have positive or negative refractive power. For example, the sub-microlens arrays 1310A″, 1330A″, and 1340A″ may have positive refractive power, while the sub-microlens array 1320A″ may have negative refractive power.

In this embodiment, in the sub-light-transmitting substrate 1410A″ closest to the fiber array 20″, the sub-microlens array 1310A″ may be disposed on the side close to the photonic integrated circuit 1200″, and the sub-light-transmitting substrate 1410A″ is bonded to the fiber array 20″ on the side close to the fiber array 20″.

FIG. 24 is a schematic diagram of an optical transceiver system according to a third embodiment of the disclosure. Referring to FIG. 24, the optical transceiver system 3B″ is similar to the optical transceiver system 3A″ in FIG. 23. The main difference is that the microlens array 1300B″ may include sub-microlens arrays 1310B″, 1320B″, and 1330B″, and the light-transmitting substrate 1400B″ may include sub-light-transmitting substrates 1410B″, 1420B″, and 1430B″. In the sub-light-transmitting substrate 1430B″ closest to the photonic integrated circuit 1200″, the sub-microlens array 1330B″ is disposed on the side close to the fiber array 20″, and the sub-light-transmitting substrate 1430B″ is bonded to the photonic integrated circuit 1200″ on the side close to the photonic integrated circuit 1200″.

In other words, traditional optical transceiver systems suffer from coupling efficiency loss due to the mismatch in optical mode size between the fiber array and the photonic integrated circuit. Therefore, in the optical transceiver system 3″ of FIG. 20A to the optical transceiver system 3B″ of FIG. 24, the optical transceiver systems 3″, 3A″, and 3B″ may use the structure of the microlens array 1300″ for the coupling between the fiber array 20″ and the photonic integrated circuit 1200″, thus improving the coupling efficiency of the system. Moreover, the microlens array 1300″ further provides advantages of lower fabrication cost and not occupying chip space. In addition, due to the simplicity of the fabrication process of the microlens array 1300″, it may be designed and adjusted in accordance with the required optical mode, thereby shortening product development time and further reducing costs.

To sum up, in one embodiment of the disclosure, the optical transceiver includes a transmitter, an optical fiber bundle, and a receiver. The transmitter includes a light source array, which includes multiple light sources. Each of light sources is configured to emit multiple lights with different wavelengths. The receiver includes a photosensor array, which includes multiple photosensors. One end of the optical fiber bundle is coupled to the transmitter, and an other end of the optical fiber bundle is coupled to the receiver, so that the photosensors are configured to receive the lights emitted by the light sources. In other words, optical transceivers use multi-wavelength light sources for transmission, thus increasing the transmission density and bandwidth of the channel.

What is claimed is:

1. An optical transceiver, comprising:
a transmitter, comprising a light source array, wherein the light source array comprises:
a plurality of light sources, wherein each of the light sources is configured to emit a plurality of lights with different wavelengths;
an optical fiber bundle, comprising a plurality of channels, wherein one end of the optical fiber bundle is coupled to the transmitter; and
a receiver, comprising a photosensor array, wherein the photosensor array comprises:
a plurality of photosensors, wherein an other end of the optical fiber bundle is coupled to the receiver, so that the photosensors are configured to receive the lights emitted by the light sources,
wherein each of the light sources is coupled to at least one of the channels of the optical fiber bundle, and each of the photosensors, corresponding to one of the light sources, is coupled to the at least one of the channels of the optical fiber bundle.

2. The optical transceiver according to claim 1, wherein the light source array is a micro light-emitting diode array.

3. The optical transceiver according to claim 1, wherein the photosensor array is a photodiode array formed of silicon, germanium, III-V semiconductors, or nitride semiconductors.

4. The optical transceiver according to claim 1, wherein each of the light sources is coupled to at least two of the channels of the optical fiber bundle, and each of the photosensors, corresponding to the one of the light sources, is coupled to the at least two of the channels of the optical fiber bundle,
wherein the light sources are spaced by a first pitch, the channels are spaced by a second pitch, and the photosensors are spaced by a third pitch, wherein the first pitch is greater than or equal to twice the second pitch, and the third pitch is greater than twice the second pitch.

5. The optical transceiver according to claim 1,
wherein each of the light sources in the light source array comprises a plurality of sub-light sources,
wherein each of the photosensors in the photosensor array comprises a plurality of sub-photosensors, positions of the sub-photosensors correspond to positions of the one of the sub-light sources of the light source, respectively, so as to receive the lights with different wavelengths, respectively.

6. The optical transceiver according to claim 5,
wherein the sub-light sources are configured to emit the lights with different wavelengths, respectively,
wherein the optical transceiver further comprises: a bandpass filter array, comprising a plurality of bandpass filters, corresponding to positions of the light sources, respectively, and disposed between the optical fiber bundle and the receiver, wherein each of the bandpass filters comprises a plurality of sub-bandpass filters, the sub-bandpass filters have different passbands, respectively, correspond to positions of the sub-light sources, respectively, and are disposed between the optical fiber bundle and the receiver.

7. The optical transceiver according to claim 6, wherein each of the light sources is coupled to at least two of the channels of the optical fiber bundle, and each of the photosensors, corresponding to the one of the light sources, is coupled to the at least two of the channels of the optical fiber bundle,
wherein the light sources are spaced by a first pitch, the channels are spaced by a second pitch, and the photosensors are spaced by a third pitch, wherein the first pitch is greater than or equal to twice the second pitch, and the third pitch is greater than twice the second pitch.

8. The optical transceiver according to claim 6, wherein the sub-light sources are wavelength-tunable light sources.

9. The optical transceiver according to claim 8, wherein each of the light sources is coupled to at least two of the channels of the optical fiber bundle, and each of the photosensors, corresponding to the one of the light sources, is coupled to the at least two of the channels of the optical fiber bundle,
wherein the light sources are spaced by a first pitch, the channels are spaced by a second pitch, and the photosensors are spaced by a third pitch, wherein the first pitch is greater than or equal to twice the second pitch, and the third pitch is greater than twice the second pitch.

10. The optical transceiver according to claim 5,
wherein each of the light sources of the light source array further comprises a plurality of wavelength conversion elements, the wavelength conversion elements correspond to positions of the sub-light sources, respectively, and are disposed between the sub-light sources and the optical fiber bundle, so as to convert the light emitted by the sub-light sources into the lights with different wavelengths, respectively,
wherein the optical transceiver further comprises: a bandpass filter array, comprising a plurality of bandpass filters, corresponding to positions of the light sources, respectively, and disposed between the optical fiber bundle and the receiver, wherein each of the bandpass filters comprises a plurality of sub-bandpass filters, the sub-bandpass filters have different passbands, respectively, correspond to positions of the sub-light sources, respectively, and are disposed between the optical fiber bundle and the receiver.

11. The optical transceiver according to claim 10, wherein each of the light sources is coupled to at least two of the channels of the optical fiber bundle, and each of the photosensors, corresponding to the one of the light sources, is coupled to the at least two of the channels of the optical fiber bundle,
wherein the light sources are spaced by a first pitch, the channels are spaced by a second pitch, and the photosensors are spaced by a third pitch, wherein the first pitch is greater than or equal to twice the second pitch, and the third pitch is greater than twice the second pitch.

12. The optical transceiver according to claim 5, wherein the sub-photosensors are micro light-emitting diodes with reverse bias applied.

13. The optical transceiver according to claim 12, wherein each of the light sources is coupled to at least two of the channels of the optical fiber bundle, and each of the photosensors, corresponding to the one of the light sources, is coupled to the at least two of the channels of the optical fiber bundle,
wherein the light sources are spaced by a first pitch, the channels are spaced by a second pitch, and the photosensors are spaced by a third pitch, wherein the first pitch is greater than or equal to twice the second pitch, and the third pitch is greater than twice the second pitch.

14. The optical transceiver according to claim 1, wherein the transmitter further comprises:
a plurality of auxiliary light sources, disposed around the light source array, wherein each of the auxiliary light sources is configured to couple to at least one of the channels to assist in alignment between the light source array and the optical fiber bundle.

15. The optical transceiver according to claim 14, wherein the light source array and the channels are arranged into a square matrix, and a length and a width of the square matrix formed by the light source array are parallel or perpendicular to a length and a width of the square matrix formed by the channels.

16. The optical transceiver according to claim 14, wherein the light source array and the channels are arranged in a square matrix, and a length and a width of the square matrix formed by the light source array are not parallel and not perpendicular to a length and a width of the square matrix formed by the channels.

17. The optical transceiver according to claim 1, wherein the transmitter further comprises a plurality of auxiliary light sources, and the optical fiber bundle further comprises a plurality of auxiliary channels,
wherein the auxiliary light sources are disposed around the light source array, and the auxiliary channels are disposed around the channels,
wherein each of the auxiliary light sources is configured to couple to one of the auxiliary channels to assist in alignment between the light sources of the light source array and the channels of the optical fiber bundle.
